(19) United States
(12) Patent Application Publication
(10) Pub. No.: US 2025/0198741 A1
(43) Pub. Date: Jun. 19, 2025

(54) METHOD FOR CALIBRATING A MEASUREMENT SCANNER ON A LASER-WORKING OPTICAL UNIT

(71) Applicant: TRUMPF Laser GmbH, Schramberg (DE)

(72) Inventors: Jan-Patrick Hermani, Markgröningen (DE); Martin Stambke, Aichhalden (DE); Andreas Trost, Aichhalden (DE); Ingo Kahl, Hornberg (DE)

(21) Appl. No.: 19/044,649

(22) Filed: Feb. 4, 2025

Related U.S. Application Data
(63) Continuation of application No. PCT/EP2023/070395, filed on Jul. 24, 2023.

(30) Foreign Application Priority Data
Aug. 18, 2022 (DE) 10 2022 120 834.6

(51) Int. Cl. G01B 9/02055; G01B 9/02091

(52) U.S. Cl. CPC G01B 9/02072; G01B 9/02091

(57) ABSTRACT

A method for calibrating a measurement scanner on a laser-working optical unit of a laser working device includes creating a measurement scan of a test body using a measurement beam, and comparing measurement scan data the measurement scan with reference data of the test body, and if the measurement scan data of the measurement scan deviate from the reference data, correcting the measurement scanner so that the measurement scan data and the reference data of the test body match.

### CROSS REFERENCE TO RELATED APPLICATIONS

This application is a continuation of International Application No. PCT/EP2023/070395 (WO 2024/037828 A1), filed on Jul. 24, 2023, and claims benefit to German Patent Application No. DE 10 2022 120 834.6, filed on Aug. 18, 2022. The aforementioned applications are hereby incorporated by reference herein.

### FIELD

Embodiments of the present invention relate to a method for calibrating a measurement scanner on a laser-working optical unit of a laser working device.

### BACKGROUND

The calibration of a measurement scanner on a laser-working optical unit requires complex sensors to measure the measurement beam in different positions of the measurement scanner. This calibration procedure is carried out as a singular occurrence before the commissioning of a laser working device. However, replacement of components of the laser working device and/or collisions during workpiece processing can cause the factory calibration of the measurement scanner to become incorrect. Such inaccurate measuring data can cause the laser beam to strike the workpiece to be processed in the wrong position, which leads to quality losses during laser processing of the workpiece. The user of the laser working device is not currently able to subsequently check the calibration and, if necessary, readjust the measurement scanner.

From DE 10 2016 106 648 B4, it is known to calibrate a measuring device on a laser-working optical unit by shooting a known pattern into a sheet metal part with the machining laser beam and then scanning this with the measuring device. The scanned actual data of the sample are compared with the known target data of the sample and, if necessary, the calibration of the measuring device is readjusted.

However, this known method is relatively inaccurate. In addition, the result depends on the aspect ratios of the laser beam and the material of the sheet metal part.

### SUMMARY

Embodiments of the present invention provide a method for calibrating a measurement scanner on a laser-working optical unit of a laser working device. The method includes creating a measurement scan of a test body using a measurement beam, and comparing measurement scan data the measurement scan with reference data of the test body, and if the measurement scan data of the measurement scan deviate from the reference data, correcting the measurement scanner so that the measurement scan data and the reference data of the test body match.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser working device with a laser-working optical unit and a measurement scanner according to some embodiments;

FIG. 2 shows a plan view of a test body with a circular marking according to some embodiments; and

FIG. 3 shows x-y coordinate systems of a target state and an actual state of a measurement scan according to some embodiments.

### DETAILED DESCRIPTION

Embodiments of the invention can enable a calibration of a measurement scanner on a laser-working optical unit, which can be carried out fully automatically and with high accuracy.

According to some embodiments, a method for calibrating a measurement scanner on a laser-working optical unit is provided, wherein a measurement scan of a test body is created using a measurement beam, and the measurement scan is subsequently compared with reference data of the test body, wherein, if the measurement scan data of the measurement scan deviate from the reference data, a measurement scanner is corrected so that the measurement scan data and the reference data of the test body match. The test body is arranged at the focal point or on the focal plane or adjacent to the focal point or the focal plane.

The test body used can be reused as often as required. The result of the calibration does not depend on the quality of the laser optical unit or processing optical unit or on the material of the test body, as is the case with the known method of inserting a reference sample into a sheet metal part. Calibration can therefore be carried out with very high accuracy.

To carry out the method, a test body with known dimensions can be used, wherein the known dimensions are used as reference data for comparing the measurement scan data from a measurement scanner of the laser working device. The reference data can be stored as target data in an evaluation device, with which the measured actual data of the measurement scan are compared.

Alternatively, however, a test body with unknown dimensions can be used. In this alternative, the measurement beam is provided by the laser-working optical unit, wherein the measurement beam is deflected by the laser-working optical unit to create a measurement scan of the test body and the scan data of the measurement scan of the measurement beam from the laser-working optical unit are used as reference data, which is compared with scan data of a measurement scan of the test body subsequently carried out with the measurement beam of the measurement scanner. Accordingly, the test body is first scanned or swept with the measurement beam from the laser-working optical unit and then scanned or swept with the measurement beam of the measurement scanner. In the alternative, to create the reference data, the measurement beam is not provided by the measurement scanner, but is instead provided and deflected by the laser-working optical unit. In the alternative, a measurement scan is then created using the optical unit of the measurement scanner and compared with the reference data. In this method variant or alternative, different test bodies can be used, which also facilitates the verification of the calibration of the measurement scanner by a user of the laser working device.

Preferably, after correcting the measurement scanner, a new measurement scan of the test body is created and compared with the reference data to ensure that the corrective measures taken on the measurement scanner were successful.

The measurement scan can be used to create a three-dimensional model of the test body. In this way, it is possible to calibrate the measurement scanner not only in the lateral direction, but also in the direction of the axis of the machining laser beam. A precise adjustment of the focus of the machining laser beam on a workpiece to be processed is essential for a good processing result, for example in laser welding or laser cutting. This criterion can also be checked with the measurement scanner and, if necessary, the distance between the laser optical unit and a workpiece can be corrected.

Preferably, a circular test body or a test body with a circular feature or marking is used for calibration. In the measurement scan, the semi-axes of the circular marking or of the test body are measured in the x- and y-directions. If the measurement scan deviates in the x- and/or y-direction, the volume model of the test body or the circular marking in the volume model of the test body appears as elliptical or oval and no longer as circular. The roundness of a body is relatively easy to check visually. If the measured semi-axis in the x-direction is, for example, x=r+a, wherein r is the radius of the test body or its circular marking, the deflection of the measurement scanner in the x-direction is then corrected by the factor x/(x+a). Analogously, a deviation of the semi-axis in the y-direction y=r+b can be compensated by correcting the measurement scanner in the y-direction by the factor y=y/(y+b).

An OCT (optical coherence tomography) scanner of an optical coherence tomograph can preferably be used as a measurement scanner. In such OCT scanners, an object is irradiated with light of low coherence length and reflected and/or scattered light is compared with a reference beam using an interferometer. The test body is scanned at specific points with the OCT scanner, also known as the OCT measurement scanner, and its contour is recorded with a very high resolution. OCT scanners are characterized by high accuracy or sensitivity as well as high measurement speed.

Exemplary embodiments of the invention are described in more detail below with reference to the figures.

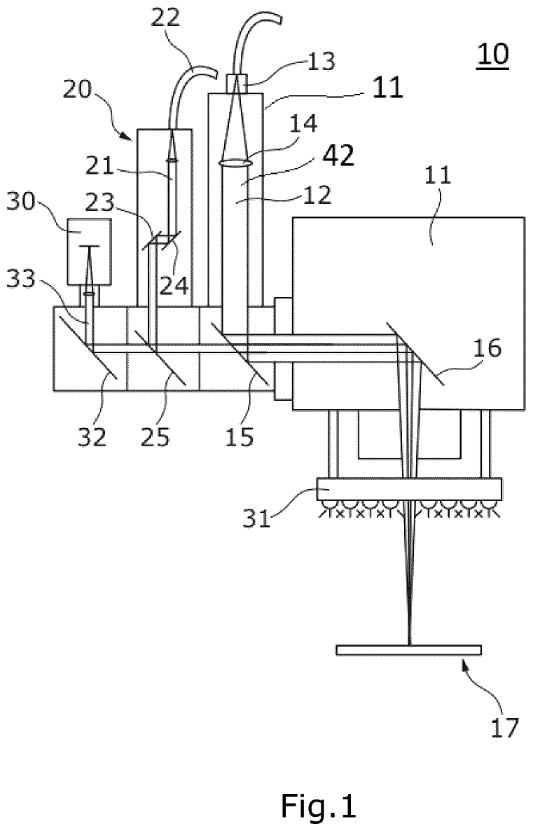

An exemplary schematic side view of a laser working device 10 shown in FIG. 1 has a laser-working optical unit 11, which receives a machining laser beam 12 from a laser source (not shown) via a fiber-optic cable 13 or an optical waveguide, and comprises at least one optical unit 14, through which the machining laser beam 12 passes. The optical unit 14 is designed as a collimator lens for collimating the incident machining laser beam 12. The laser working device 10 can be designed for different processing of workpieces by means of laser radiation, for example for welding or cutting workpieces. A first mirror 15 and a second mirror 16 are arranged within the laser-working optical unit 11, each of which deflects the machining laser beam 12 by 90°, wherein a lens optical unit (not shown here) focuses the machining laser beam 12 onto a test body 17. Further optical elements can be included in the laser-working optical unit 11. The method described here refers to a calibration process; the machining laser beam 12 for processing a workpiece is not used in the method.

Also coupled to the laser working device 10 is a measurement scanner 20, which can preferably be arranged in an exchangeable manner and designed as an OCT scanner. The measurement scanner 20 is arranged in FIG. 1 to the left of the laser-working optical unit 11. The measurement scanner 20 receives a measurement laser beam or measurement beam 21 via an optical waveguide 22. The measurement beam 21 is guided via a first mirror 23 and a second mirror 24 of the measurement scanner 20, which usually deflect the measurement beam 21 two-dimensionally, to a third mirror 25, which couples the measurement beam 21 coaxially into the machining laser beam 12 via the first mirror 15 of the laser-working optical unit 11, which is transparent to the measurement beam 21. The measurement beam 21 is then focused together with the machining laser beam 12 onto the test body 17 via the second mirror 16 of the laser-working optical unit 11.

The laser working device 10 is also equipped with a camera 30 and a lighting device 31. The camera 30 picks up light reflected back 33 from the test body 17, which is directed from the mirror 16 in the laser-working optical unit 11 and a mirror 32 to the camera 30.

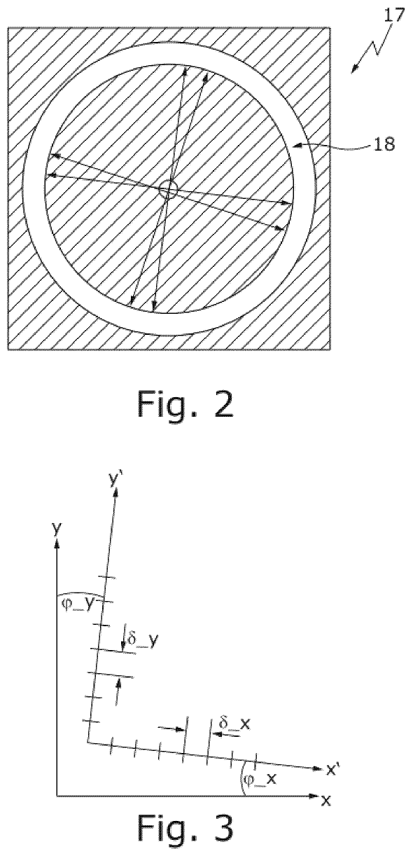

FIG. 2 shows a schematic detailed representation of the test body 17, which has a circular marking 18.

In a first process variant, the test body 17 with known dimensions, in particular with a known radius r of the marking 18, is inserted into the focal point of the machining laser beam 12. Subsequently, with the machining laser beam 12 switched off, the test body 17 is scanned point by point in the x- and y-directions by the measurement beam 21 of the measurement scanner 20 with the aid of the first mirror 15 and the second mirror 16 of the laser-working optical unit 11 and a three-dimensional measurement scan of the test body 17 is created. The x-y coordinate system in FIG. 3 indicates the target coordinate system, while the x′-y′ coordinate system is the coordinate system that has actually been measured by the measurement scanner 20. The data of the dimensions of the test body 17 from the measurement scan are compared with stored target data of the known test body 17 in an evaluation device (not shown here). In particular, it is checked whether the marking 18 is also circular in the measurement scan and has the known radius of r. If it is found that the radius of the measurement scan in the x-direction deviates from the known radius r by a distance a, where a can have a positive or negative value, the calibration of the measurement scanner 20 in the x-direction is corrected by the factor x/(x+a). In the same way, the calibration of the measurement scanner 20 in the y-direction can be corrected if the radius of the marking 18 in the measurement scan deviates by an amount b. The correction factor is then y/(y+b).

After correcting the calibration of the measurement scanner 20, a new measurement scan is created and checked to see whether the previously detected deviations of the measurement scan from the target values have been corrected. FIG. 3 illustrates how the measurements are taken: The test body 17 is scanned by the measurement beam 21 in increments of 8× in the x-direction and of dy in the y-direction. If the resolution in x- and y-directions is correct, the measurement scan will produce a circular marking with the radius r. However, if the resolution deviates in the x- and/or y-direction, the measured values deviate from the target values of the test body 17, and the measurement scanner 20 is readjusted in a subsequent work step. In addition to deviations in the x- and y-directions, angular deviations q_x and o_y are also measured and corrected if necessary.

In a second method variant, a test body 17 with unknown dimensions of the circular marking 18 or feature is used. The test body 17 is first scanned by the laser-working optical unit 11, wherein a measurement beam 42 of the laser-working optical unit 11 is supplied from the fiber-optic cable 13 or optical waveguide via the laser-working optical unit 11 in the second method variant. The low-power measurement beam 42 of the laser-working optical unit 11 passes through the laser-working optical unit 11 instead of the high-power machining laser beam 12; this measurement beam 42 is defined as the measurement beam 42 of the laser-working optical unit 11. The laser source therefore generates either the high-power machining laser beam 12 for processing a workpiece or the measurement beam 42 of the laser-working optical unit 11 for scanning the test body 17. The measurement beam 42 is deflected by the first mirror 15 and the second mirror 16 of the laser-working optical unit 11. The volume model of the test body 17 created in this way is then used as a reference model for a subsequent measurement scan created with the measurement beam 21 by the measurement scanner 20, as described above. The measurement beam 21, which is supplied to the measurement scanner 20 from the optical waveguide 22 and passes through the measurement scanner 20, is defined as the measurement beam 21 of the measurement scanner 20, which scans or sweeps over the test body 17 similarly to the measurement beam 42 of the laser-working optical unit 11. Here too, as in the first method variant, deviations of the recorded data of the measurement scan from the reference values in the x- and y-directions as well as angular deviations are detected and, if necessary, corrected by changing the calibration of the measurement scanner 20.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Laser working device
11 Laser-working optical unit
12 Machining laser beam
13 Fiber-optic cable
14 Optical unit
15 First mirror of the laser-working optical unit
16 Second mirror of the laser-working optical unit
17 Test body
18 Marking
20 Measurement scanner
21 Measurement beam of the measurement scanner
22 Optical waveguide
23 First mirror of the measurement scanner
24 Second mirror of the measurement scanner
25 Third mirror
30 Camera
31 Lighting device
32 Mirror
33 Back-reflected light
42 Measurement beam of the laser-working optical unit

1. A method for calibrating a measurement scanner on a laser-working optical unit of a laser working device, the method comprising:
creating a measurement scan of a test body using a measurement beam, and
comparing measurement scan data the measurement scan with reference data of the test body, and
if the measurement scan data of the measurement scan deviate from the reference data, correcting the measurement scanner so that the measurement scan data and the reference data of the test body match.

2. The method according to claim 1, wherein the measurement beam is deflected by the measurement scanner, wherein the test body with known dimensions is used, and the known dimensions are used as the reference data for the comparison of the measurement scan data.

3. The method according to claim 1, wherein the measurement beam is provided by the laser-working optical unit, wherein the test body with unknown dimensions is used, and the measurement beam is deflected by the laser-working optical unit to create the measurement scan of the test body, and scan data of the measurement scan of the measurement beam from the laser-working optical unit are used as reference data, which are compared with the measurement scan data of the measurement scan of the test body subsequently carried out with the measurement beam of the measurement scanner.

4. The method according to claim 3, wherein the measurement beam supplied from the laser-working optical unit to the test body is supplied to the laser-working optical unit via a fiber-optic cable.

5. The method according to claim 1, further comprising, after the correction of the measurement scanner, creating a new measurement scan, and comparing new measurement scan data of the new measurement scan with the reference data.

6. The method according to claim 1, wherein a three-dimensional model of the test body is created using the measurement scan.

7. The method according to claim 1, wherein the test body is a circular test body or has a circular marking.

8. The method according to claim 7, wherein semi-axes of the circular marking or of the test body are measured in x- and y-directions.

9. The method according to claim 1, wherein an OCT scanner is used as the measurement scanner, wherein the measurement beam is an OCT measurement beam.
